(19) United States
(12) Patent Application Publication
(10) Pub. No.: US 2010/0003542 A1
(43) Pub. Date: Jan. 7, 2010

(54) Coating of artificial surfaces of medical aids and instruments, and cleaning and/or pretreatment of catheters and other medical aids and instruments

(75) Inventors: Elisabeth Perzborn, Wuppertal (DE); Frank Misselwitz, Heidelberg-Neuenheim (DE)

Correspondence Address: EDWARDS ANGELL PALMER & DODGE LLP, P.O. BOX 55874, BOSTON, MA, 02205, US

(73) Assignee: BAYER SCHERING PHARMA AKTIENGESSELSCHAFT, Berlin (DE)

(21) Appl. No.: 12/375,016

(22) PCT Filed: Jul. 16, 2007
(86) PCT No.: PCT/EP07/06282

§ 371 Date: Sep. 2, 2009

(30) Foreign Application Priority Data
Jul. 28, 2006 (DE) 10 2006 034 916.4

(51) Int. Cl. B32B 9/04

(52) U.S. Cl. 428/704

(57) ABSTRACT

The present invention relates to the use of factor Xa (FXa) inhibitors with anticoagulant action for the antithrombotic coating and/or treatment of artificial surfaces of medical aids and/or devices for the prevention of fibrin deposits and/or formation of blood clots and of thrombi, and the use of FXa inhibitors in the cleaning and/or pretreatment of catheters and other medical aids and devices.

The present invention relates to the use of factor Xa (FXa) inhibitors with anticoagulant action for the antithrombotic coating and/or treatment of artificial surfaces of medical aids and/or devices for the prevention of fibrin deposits and/or formation of blood clots and of thrombi, and the use of FXa inhibitors in the cleaning and/or pretreatment of catheters and other medical aids and devices.

The use of artificial surfaces is of considerable importance for medical applications, however their use is considerably restricted since artificial surfaces are often not biocompatible. Their use in medical technology often causes problems on account of the adsorption/attachment of proteins and blood platelets on many surfaces and the thrombogenicity of the surfaces used resulting from this as soon as these come into contact with body fluids such as blood or blood products. Because of the contact, the intrinsic blood clotting system is activated (contact activation). This contact activation leads to the activation of the blood clotting factor X (FX) to FXa. FXa in turn cleaves prothrombin to thrombin (FIIa) and thus causes the blood clotting and hence clot formation or thrombus formation. In addition, the platelets (thrombocytes) are activated by adhesion to artificial surfaces. Activated platelets have a reinforcing action in the clotting process. The functioning of the medical aid or device can be adversely affected by the blood clot. In addition, thrombus formation can occur and hence vascular occlusion or thromboembolisms, the cause of various thromboembolic complications such as cardiac infarction, cerebral infarction and pulmonary embolisms.

Substances which inhibit the activity of FXa and thus prevent the formation of thrombin, prevent the blood clotting triggered by contact activation and thus fibrin deposits and thrombus formation.

The systemic administration of FXa inhibitors for the prevention of fibrin deposits and thrombus formation on artificial surfaces is complicated by the fact that on the one hand, depending on the use of the artificial surface, the anticoagulant has to be administered over a long period, and haemorrhagic complications could occur, both in short-term and in long-term use. The coating of artificial surfaces with an FXa inhibitor renders local prolonged medical treatment possible and could therefore offer considerable advantages. Thus, the combination of a medical aid or device with FXa inhibitors enables a high local concentration of active substance, without the occurrence of the undesired systemic side-effects (e.g. haemorrhages or stroke).

For this, a medical aid and/or device can be coated with active substance-containing lacquer materials. Release of the active substance occurs by diffusion from the lacquer or by degradation of the lacquer if biodegradable lacquer systems are used.

Another previously described possibility is the preparation of small cavities or micropores in the surface of a medical aid and/or device, in which the active substance or else active substance-containing polymeric lacquer systems can be embedded (see for example EP-A-0 950 386). Next, an active substance-free lacquer can be applied. Release takes place through diffusion or degradation or by a combination of both processes.

In addition, active substance-containing medical aids and/or devices can be produced by melt-embedding of the active substance into a polymeric carrier, for example by means of injection moulding processes. With these medical aids and/or devices, release of the active substance as a rule takes place by diffusion.

Factor Xa inhibitors which are suitable for the coating of medical foreign surfaces are described in WO 01/047919. The substances described are potent, selective FXa inhibitors which inhibit the extrinsic and the intrinsic blood clotting system and can therefore be used for the prevention of contact activation.

Surprisingly, it has now been found that oxazolidinones of the formula (I), which in particular act as anticoagulants and as selective inhibitors of the blood clotting factor Xa and are described in detail in WO 01/47919, are suitable for this type of treatment. The compounds mentioned there in general and above all the compounds specifically described there are an express descriptive component of the present invention.

The present invention relates to the use of one or more compounds of the formula (I)

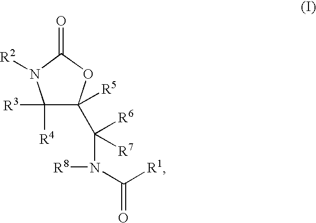

in which
R¹ stands for optionally benzocondensed thiophen (thienyl), which can optionally be singly or multiply substituted;
R² stands for any organic residue;
R³, R⁴, R⁵, R⁶, R⁷ and R⁸ are the same or different and stand for hydrogen or for (C₁-C₆)alkyl,
   and salts thereof, solvates thereof and the solvates of salts thereof
   for the coating and/or treatment of artificial surfaces of medical aids and/or devices.

Preferred is the use of compounds of the formula (I) in which
R¹ stands for optionally benzocondensed thiophen (thienyl), which can optionally be singly or multiply substituted with a residue from the group of halogen, cyano, nitro, amino, aminomethyl and (C₁-C₈)alkyl, which can itself optionally be singly or multiply substituted with halogen, (C₃-C₇)cycloalkyl, (C₁-C₈)alkoxy, imidazolinyl, —C(═NH)NH₂, carbamoyl, and mono- and di-(C₁-C₄)alkylaminocarbonyl,
R² stands for one of the following groups:
   A-,
   A-M-,
   D-M-A-,
   B-M-A-,
   B—,
   B-M-,
   B-M-B—,
   D-M-B—,
   where
   the residue “A” stands for (C₆-C₁₄) aryl, preferably for (C₆-C₁₀) aryl, in particular for phenyl or naphthyl, quite especially preferably for phenyl;
   the residue “B” stands for a 5- or 6-membered aromatic heterocycle, which contains up to 3 hetero atoms and/or hetero chain members, in particular up to 2 hetero atoms and/or hetero chain members, from the range S, N, NO(N-oxide) and O;
   the residue “D” stands for a saturated or partly unsaturated, mono- or bicyclic, optionally benzocondensed 4- to 9-membered heterocycle, which contains up to three hetero atoms and/or hetero chain members from the range S, SO, SO₂, N, NO(N-oxide) and O;
   the residue “M” stands for —NH—, —CH₂—, —CH₂CH₂—, —O—, —NH—CH₂—, —CH₂—NH—, —OCH₂—, —CH₂O—, —CONH—, —NHCO—, —COO—, —OOC—, —S—, —SO₂— or for a covalent bond;
   where
   the previously defined groups “A”, “B” and “D” can each optionally be singly or multiply substituted with a residue from the group of halogen, trifluoromethyl, oxo, cyano, nitro, carbamoyl, pyridyl, (C₁-C₆) alkanoyl, (C₃-C₇) cycloalkanoyl, (C₆-C₁₄) arylcarbonyl, (C₅-C₁₀) heteroarylcarbonyl, (C₁-C₆) alkanoyloxymethyloxy, (C₁-C₄) hydroxyalkyl-carbonyl, —COR²⁷, —SO₂R²⁷, —C(NR²⁷R²⁸)═NR²⁹, —CONR²⁸R²⁹, —SO₂NR²⁸R²⁹, —OR³⁰, —NR³⁰R³¹, (C₁-C₆) alkyl and (C₃-C₇) cycloalkyl,
   where (C₁-C₆) alkyl and (C₃-C₇) cycloalkyl can themselves optionally be substituted with a residue from the group of cyano, —OR²⁷, —NR²⁸R²⁹, —CO(NH)ᵥ(NR²⁷R²⁸) and —C(NR²⁷R²⁸)═NR²⁹,
   where
   v means either 0 or 1 and
   R²⁷, R²⁸ and R²⁹ are the same or different and mutually independently mean hydrogen, (C₁-C₄) alkyl, (C₃-C₇) cycloalkyl, (C₁-C₄) alkanoyl, carbamoyl, trifluoromethyl, phenyl or pyridyl,
   and/or
   R²⁷ and R²⁸ or R²⁷ and R²⁹ respectively, together with the nitrogen atom to which they are bound form a saturated or partly unsaturated 5- to 7-membered heterocycle with up to three, preferably up to two identical or different hetero atoms from the group of N, O and S, and
   R³⁰ and R³¹ are the same or different and mutually independently mean hydrogen, (C₁-C₄) alkyl, (C₃-C₇) cycloalkyl, (C₁-C₄) alkylsulphonyl, (C₁-C₄) hydroxyalkyl, (C₁-C₄) aminoalkyl, di-(C₁-C₄) alkylamino-(C₁-C₄) alkyl, —CH₂C(NR²⁷R²⁸)═NR²⁹ or —COR³³,
   where
   R³³ means (C₁-C₆) alkoxy, (C₁-C₄) alkoxy-(C₁-C₄) alkyl, (C₁-C₄) alkoxycarbonyl-(C₁-C₄) alkyl, (C₁-C₄) aminoalkyl, (C₁-C₄) alkoxycarbonyl, (C₁-C₄) alkanoyl-(C₁-C₄) alkyl, (C₃-C₇) cycloalkyl, (C₂-C₆) alkenyl, (C₁-C₈) alkyl, which can
   optionally be substituted with phenyl or acetyl, (C₆-C₁₄) aryl, (C₅-C₁₀) heteroaryl, trifluoromethyl, tetrahydrofuranyl or butyrolactone,
R³, R⁴, R⁵, R⁶, R⁷ and R⁵ are the same or different and stand for hydrogen or for (C₁-C₆) alkyl,
   and salts thereof, solvates thereof and the solvates of salts thereof
   for the coating and/or treatment of artificial surfaces of medical aids and/or devices.

Also preferred is the use of compounds of the formula (I) in which
R¹ stands for thiophen (thienyl), in particular 2-thiophen, which can optionally be singly or multiply substituted with halogen, preferably chlorine or bromine, amino, aminomethyl or (C₁-C₈) alkyl, preferably methyl, where the (C₁-C₈) alkyl residue can itself optionally be singly or multiply substituted with halogen, preferably fluorine,
R² stands for one of the following groups:
   A-,
   A-M-,
   D-M-A-,
   B-M-A-,
   B—,
   B-M-,
   B-M-B—,
   D-M-B—,
   where
   the residue “A” stands for (C₆-C₁₄) aryl, preferably for (C₆-C₁₀) aryl, in particular for phenyl or naphthyl, quite especially preferably for phenyl;
   the residue “B” stands for a 5- or 6-membered aromatic heterocycle, which contains up to 3 hetero atoms and/or hetero chain members, in particular up to 2 hetero atoms and/or hetero chain members, from the range S, N, NO(N-oxide) and O;
   the residue “D” stands for a saturated or partly unsaturated 4- to 7-membered heterocycle, which contains up to three hetero atoms and/or hetero chain members from the range S, SO, SO₂, N, NO(N-oxide) and O;
   the residue “M” stands for —NH—, —CH₂—, —CH₂CH₂—, —O—, —NH—CH₂—, —CH₂—NH—, —OCH₂—, —CH₂O—, —CONH—, —NHCO—, —COO—, —OOC—, —S— or for a covalent bond;
   where
   the previously defined groups “A”, “B” and “D” can each optionally be singly or multiply substituted with a residue from the group of halogen, trifluoromethyl, oxo, cyano, nitro, carbamoyl, pyridyl, (C₁-C₆) alkanoyl, (C₃-C₇) cycloalkanoyl, (C₆-C₁₄) arylcarbonyl, (C₅-C₁₀) heteroarylcarbonyl, (C₁-C₆) alkanoyloxymethyloxy; —COOR²⁷—SO₂R²⁷, —C(NR²⁷R²⁸)═NR²⁹, —CONR²⁸R²⁹, —SO₂NR²⁸R²⁹—OR³⁰, —NR³⁰R³¹,(C₁-C₆) alkyl and (C₃-C₇) cycloalkyl,
   where (C₁-C₆) alkyl and (C₃-C₇) cycloalkyl can themselves optionally be substituted with a residue from the group of cyano, —OR²⁷, —NR²⁸R²⁹, —CO(NH)ᵥ(NR²⁷R²⁸) and —C(NR²⁷R²⁸)═NR²⁹
   where
   v means either 0 or 1 and
   R²⁷, R²⁸ and R²⁹ are the same or different and mutually independently mean hydrogen, (C₁-C₄) alkyl or (C₃-C₇) cycloalkyl, and/or
   R²⁷ and R²⁸ or R²⁷ and R²⁹ respectively together with the nitrogen atom to which they are bound form a saturated or partly unsaturated 5- to 7-membered heterocycle with up to three, preferably up to two identical or different hetero atoms from the group of N, O and S, and
   R³⁰ and R³¹ are the same or different and mutually independently mean hydrogen, (C₁-C₄) alkyl, (C₃-C₇) cycloalkyl, (C₁-C₄) alkylsulphonyl, (C₁-C₄) hydroxyalkyl, (C₁-C₄) aminoalkyl, di-(C₁-C₄) alkylamino-(C₁-C₄) alkyl, (C₁-C₄) alkanoyl, (C₆-C₁₄) arylcarbonyl, (C₅-C₁₀) heteroarylcarbonyl, (C₁-C₄) alkylaminocarbonyl or —CH₂C(NR²⁷R²⁸)═NR²⁹
R³, R⁴, R⁵, R⁶, R⁷ and R⁸ are the same or different and stand for hydrogen or for (C₁-C₆) alkyl,
   and salts thereof, solvates thereof and the solvates of salts thereof
   for the coating and/or treatment of artificial surfaces of medical aids and/or devices.

Particularly preferred is the use of compounds of the formula (I) in which
R¹ stands for thiophen (thienyl), in particular 2-thiophen, which can optionally be singly or multiply substituted with halogen, preferably chlorine or bromine, or (C₁-C₈) alkyl, preferably methyl, where the (C₁-C₈) alkyl residue can itself optionally be singly or multiply substituted with halogen, preferably fluorine,
R² stands for one of the following groups:
   A-,
   A-M-,
   D-M-A-,
   B-M-A-,
   B—,
   B-M-,
   B-M-B—,
   D-M-B—,
   wherein
   the residue “A” stands for phenyl or naphthyl, in particular for phenyl;
   the residue “B” stands for a 5- or 6-membered aromatic heterocycle, which contains up to two 2 hetero atoms from the range S, N, NO(N-oxide) and O;
   the residue “D” stands for a saturated or partly unsaturated 5- or 6-membered heterocycle, which contains up to two hetero atoms and/or hetero chain members from the range S, SO, SO₂, N, NO(N-oxide) and O;
   the residue “M” stands for —NH—, —O—, —NH—CH₂—, —CH₂—NH—, —OCH₂—, —CH₂O—, —CONH—, —NHCO— or for a covalent bond;
   where
   the previously defined groups “A”, “B” and “D” can each optionally be singly or multiply substituted with a residue from the group of halogen, trifluoromethyl, oxo, cyano, pyridiyl, (C₁-C₃) alkanoyl, (C₆-C₁₀) arylcarbonyl, (C₅-C₆) heteroarylcarbonyl, (C₁-C₃) alkanoyloxy-methyloxy, —C(NR²⁷R²⁸)═NR²⁹, —CONR²⁸R²⁸, —SO₂NR²⁸R²⁹, —OH, —NR³⁰R³¹(C₁-C₄) alkyl; and cyclopropyl, cyclopentyl or cyclohexyl,
   where (C₁-C₄) alkyl and cyclopropyl, cyclopentyl or cyclohexyl can themselves optionally be substituted with a residue from the group of cyano, —OH, —OCH₃, —NR²⁸R²⁹, —CO(NH)ᵥ(NR²⁷R²⁸) and —C(NR²⁷R²⁸)═NR²⁹,
   where
   v means either 0 or 1, preferably 0 and
   R²⁷, R²⁸ and R²⁹ are the same or different and mutually independently mean hydrogen, (C₁-C₄) alkyl or else cyclopropyl, cyclopentyl or cyclohexyl
   and/or
   R²⁷ and R²³ or R²⁷ and R²⁹ respectively together with the nitrogen atom to which they are bound can form a saturated or partly unsaturated 5- to 7-membered heterocycle with up to two identical or different hetero atoms from the group of N, O and S, and
   R³⁰ and R³¹ are the same or different and mutually independently mean hydrogen, (C₁-C₄) alkyl, cyclopropyl, cyclopentyl, cyclohexyl, (C₁-C₄) alkylsulphonyl, (C₁-C₄) hydroxyalkyl, (C₁-C₄) aminoalkyl, di-(C₁-C₄) alkylamino-(C₁-C₄) alkyl, (C₁-C₃) alkanoyl or phenylcarbonyl,
R³, R⁴, R⁵, R⁶, R⁷ and R⁵ are the same or different and stand for hydrogen or for (C₁-C₆) alkyl,
   and salts thereof, solvates thereof and the solvates of salts thereof
   for the coating and/or treatment of artificial surfaces of medical aids and/or devices.

Particularly preferred is the use of compounds of the formula (I) in which
R¹ stands for 2-thiophen, which can optionally be substituted in the 5 position with a residue from the group chlorine, bromine, methyl or trifluoromethyl,
R² stands for one of the following groups:
   A-,
   A-M-,
   D-M-A-,
   B-M-A-,
   B—,
   B-M-,
   B-M-B—,
   D-M-B—,
   where
   the residue “A” stands for phenyl or naphthyl, in particular for phenyl;
   the residue “B” stands for a 5- or 6-membered aromatic heterocycle, which contains up to two 2 hetero atoms from the range S, N, NO(N-oxide) and O;
   the residue “D” stands for a saturated or partly unsaturated 5- or 6-membered heterocycle, which contains a nitrogen atom and optionally a further hetero atom and/or hetero chain member from the range S, SO, SO₂ and O, or up to two hetero atoms and/or hetero chain members from the range S, SO, SO₂ and O;
   the residue “M” stands for —NH—, —O—, —NH—CH₂—, —CH₂—NH—, —OCH₂—, —CH₂O—, —CONH—, —NHCO— or for a covalent bond;
   where
   the previously defined groups “A”, “B” and “D” can each optionally be singly or multiply substituted with a residue from the group of halogen, trifluoromethyl, oxo, cyano, pyridiyl, (C₁-C₃) alkanoyl, (C₆-C₁₀) arylcarbonyl, (C₅-C₆) heteroarylcarbonyl, (C₁-C₃) alkanoyloxy-methyloxy, —CONR²⁸R²⁹, —SO₂NR²⁸R²⁹, —OH, —NR³⁰R³¹, (C₁-C₄) alkyl; and cyclopropyl, cyclopentyl or cyclohexyl,
   wherein (C₁-C₄) alkyl and cyclopropyl, cyclopentyl or cyclohexyl can themselves optionally be substituted with a residue from the group of cyano, —OH, —OCH₃, —NR²⁸R²⁹, —CO(NH)ᵥ(NR²⁷R²⁸) and —C(NR²⁷R²⁸)═NR²⁹
   wherein
   v means either 0 or 1, preferably 0 and
   R²⁷, R²⁸ and R²⁹ are the same or different and mutually independently mean hydrogen, (C₁-C₄) alkyl or else cyclopropyl, cyclopentyl or cyclohexyl
   and/or
   R²⁷ and R²⁸ or R²⁷ and R²⁹ respectively together with the nitrogen atom to which they are bound can form a saturated or partly unsaturated 5- to 7-membered heterocycle with up to two identical or different hetero atoms from the group of N, O and S, and
   R³⁰ and R³¹ are the same or different and mutually independently mean hydrogen, (C₁-C₄) alkyl, cyclopropyl, cyclopentyl, cyclohexyl, (C₁-C₄) alkylsulphonyl, (C₁-C₄) hydroxyalkyl, (C₁-C₄) aminoalkyl, di-(C₁-C₄) alkylamino-(C₁-C₄) alkyl, (C₁-C₃) alkanoyl or phenylcarbonyl,
R³, R⁴, R⁵, R⁶, R⁷ and R⁸ are the same or different and stand for hydrogen or for (C₁-C₄) alkyl,
   and salts thereof, solvates thereof and the solvates of salts thereof
   for the coating and/or treatment of artificial surfaces of medical aids and/or devices.

Quite particularly preferred is the use of compounds of the formula (I) in which
R¹ stands for 2-thiophen, which is substituted in the 5 position with a residue from the group chlorine, bromine, methyl or trifluoromethyl,
R² stands for D-A-:
   where
   the residue “A” stands for phenylene;
   the residue “D” stands for a saturated 5- or 6-membered heterocycle,
   which is linked with “A” via a nitrogen atom,
   which has a carbonyl group directly adjacent to the linking nitrogen atom and
   in which a carbon ring member can be replaced by a hetero atom from the range S, N and O;
   where
   the previously defined group “A” can optionally be singly or doubly substituted in the meta position relative to the linkage to the oxazolidinone with a residue from the group of fluorine, chlorine, nitro, amino, trifluoromethyl, methyl or cyano,
R³, R⁴, R⁵, R⁶, R⁷ and R⁵ stand for hydrogen,
   and salts thereof, solvates thereof and the solvates of salts thereof
   for the coating and/or treatment of artificial surfaces of medical aids and/or devices.

Also quite particularly preferred is the use of the compound from Example 44 of WO 01/47919 with the following formula 5-chloro-N-({(5S)-2-oxo-3-[4-(3-oxo-4-morpholinyl)phenyl]-1,3-oxazolidin-5-yl}methyl)-2-thiophencarboxamide

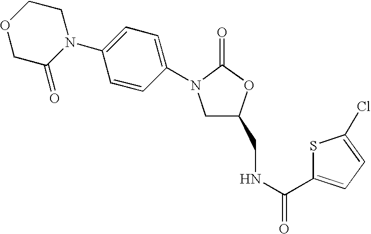

and salts thereof, solvates thereof and the solvates of salts thereof
for the coating and/or treatment of artificial surfaces of medical aids and/or devices.

Concerning the disclosure of the compounds of the formula (I), for example as regards their preparation, reference is expressly made to the disclosure of WO 01/47919.

The present invention describes the use of one or more compounds of the formula (I), optionally in combination with one or more other active substances, for the coating and/or treatment of artificial surfaces of medical aids and/or devices.

The present invention describes the use of compounds of the formula (I) for the coating and/or treatment of artificial surfaces of medical aids and/or devices for the prevention of fibrin deposition and/or thrombus formation on the surfaces thereof.

The present invention describes the use of medical aids and/or devices coated with compounds of the formula (I) for the prevention of fibrin deposition and/or thrombus formation on the surfaces thereof.

The present invention also describes a process for the prevention of fibrin deposition and/or thrombus formation on artificial surfaces, wherein one or more compounds of the formula (I) are used. In this application, the compounds of the formula (I) can be used either systemically or preferably in the form of a medical aid and/or device coated with compounds of the formula (I).

By local application of compounds of the formula (I) on a medical aid and/or device, it is possible to decrease the dose of the drug necessary for the prevention of fibrin deposits and/or thrombus formation on artificial surfaces. Undesired systemic effects can thus be minimized. At the same time, the local concentration can be increased and thus the efficacy increased.

Apart from this, in addition to the application according to the invention, systemic and/or local administration of active substances suitable for the treatment and/or prophylaxis of thromboses such as for example and preferably abciximab, eptifibatid, tirofiban, acetylsalicylic acid, ticlopidine, clopidogrel or prazugrel can be effected. Preferred is an additional systemic treatment with compounds of the formula (I), in particular by oral administration.

The present invention also describes a process for the treatment and/or prophylaxis of fibrin deposition and/or thrombus formation on artificial surfaces by the use of medical aids and/or devices which are coated with compounds of the formula (I).

The present invention also describes a process for the treatment and/or prophylaxis of fibrin deposition and/or thrombus formation on artificial surfaces by the use of medical aids and/or devices which are coated with compounds of the formula (I), in combination with local and/or systemic administration of other active substances suitable for the treatment and/or prophylaxis of fibrin deposition and/or thrombus formation on artificial surfaces.

The present invention also describes a process for the treatment and/or prophylaxis of fibrin deposition and/or thrombus formation on artificial surfaces by the use of medical aids and/or devices which are coated with compounds of the formula (I), in combination with systemic administration of compounds of the formula (I).

For the preparation of the release systems coated with compounds of the formula (I) according to the invention, normal medical aids and devices are used, the medical aid or device consisting either of glass, metal, metal alloys or non-degradable plastics such as for example and preferably polyethylene, polypropylene, polycarbonate, polyurethane and/or polytetrafluorethylene (PTFE).

The medical aids and/or devices are coated with the compounds of the formula (I). Alternatively, with non-metallic medical aids and/or devices, compounds of the formula (I) can be directly incorporated into the material used for the production of the medical aids and/or devices.

For the coating, carrier materials are mixed with the compounds of the formula (I). As carrier materials here, polymeric carriers, in particular biocompatible, non-biodegradable polymers or polymer mixtures, such as for example and preferably polyacrylates and copolymers thereof such as for example and preferably poly(hydroxyethyl)methyl methacrylates, polyvinylpyrrolidones, cellulose esters and ethers, fluorinated polymers such as for example and preferably PTFE, polyvinyl acetate and copolymers thereof, crosslinked and non-crosslinked polyurethanes, polyethers or polyesters, polycarbonates and polydimethylsiloxanes, are preferably used. Alternatively, biocompatible, biodegradable polymers or polymer mixtures, such as for example and preferably polymers or copolymers of lactide and glycolide, or of caprolactone and glycolide, other polyesters, polyortho esters, polyanhydrides, polyamino acids, polysaccharides, polyiminocarbonates, polyphosphazenes and poly(ether-ester) copolymers are also used as polymeric carriers.

Also suitable as polymeric carriers are mixtures of biodegradable and/or non-biodegradable polymers. The release rate of the active substance is optimally adjusted by means of these mixtures.

For the production of coated medical aids and/or devices, the mixtures of compounds of the formula (I) and carrier are preferably dissolved in suitable solvents. These solutions are then applied onto the medical aid and/or device by various techniques such as for example spraying, dipping or brush application. After subsequent or simultaneous removal of the solvent, the medical aid and/or device treated with active substance-containing lacquer is thus obtained. Alternatively, mixtures of compounds of the formula (I) and carrier can also be melted and applied by the same application methods.

Preferably, the medical aids and/or devices are pretreated in order to effect an increase in the external and or internal surface area of the medical aid and/or device. In this way the loading potential is increased and greater quantities of lacquer (active substance/polymer) can be applied. For the pretreatment of the medical aids and/or devices for example various etching techniques but also treatments with ionizing radiation are used. Likewise, micropores or cavities can be created in the medical aids and/or devices with the aid of various techniques.

The active substance contents of the medical aids and/or devices coated with compounds of the formula (I) are as a rule from 0.001 wt. % to 50 wt. %, preferably from 0.01 wt. % to 30 wt. %, particularly preferably 0.1 wt. % to 15 wt. %.

With non-metallic medical aids and/or devices, the compounds of the formula (I) can also be directly incorporated into the medical aids and/or devices for example as a melt embedding. Here, active substance-containing polymeric carrier mixtures are processed to the final active substance-containing form by standard processes, for example by injection moulding processes. The release of the active substance here as a rule takes place by diffusion.

The active substance contents of medical aids and/or devices with embedded compounds of the formula (I) are as a rule from 0.001 wt. % to 70 wt. %, preferably from 0.01 wt. % to 50 wt. %, particularly preferably 0.1 wt. % to 30 wt. %.

The medical aids and/or devices coated with compounds of the formula (I) are optionally coated with an additional membrane. This membrane for example and preferably serves for the control of the drug release and/or for the protection of the active substance-containing medical aids and/or devices against external influences.

In addition, FXa inhibitors can also be used for the cleaning and/or pretreatment for example of catheters and other aforesaid medical aids and devices by addition to the rinsing liquids or suitable pretreatment agents, in order to prevent contact activation by blood or blood products.

The present invention further describes the use of one or more compounds of the formula (I), optionally in combination with one or more other active substances, in the cleaning and/or pretreatment of catheters and other medical aids and devices.

Normal commercial washing liquids which are suitable for the cleaning of medical instruments are suitable as washing liquids.

Preferred is the use of the compound from Example 44 of WO 01/47919 with the following formula 5-chloro-N-({(5S)-2-oxo-3-[4-(3-oxo-4-morpholinyl)phenyl]-1,3-oxazolidin-5-yl}methyl)-2-thiophencarboxamide

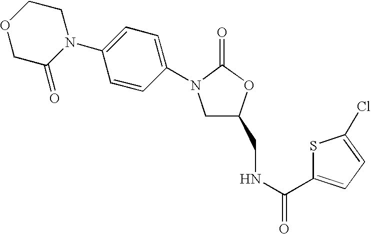

and salts thereof, solvates thereof and the solvates of salts thereof
in the cleaning and/or pretreatment of catheters and other medical aids and devices.

The present invention further describes the use of compounds of the formula (I), in the cleaning and/or pretreatment of catheters and other medical aids and devices for the prevention of fibrin deposition and/or thrombus formation on the surfaces thereof.

Medical aids and devices stands for all medical articles and apparatus with surfaces which come into contact with human blood or animal blood and blood products, for example and preferably for hypodermic needles, cannulas, tubes, connectors for tube connections, syringes, catheters, such as administration catheters, indwelling catheters, indwelling central venous lines, aids for percutaneous intravascular interventions for catheter canalization, such as balloon catheters, ablation laser catheters, intravascular laser devices, rotation catheters, atherectomy catheters, guide wires, port systems for intravenous drug delivery and surgical suture materials and drug delivery systems.

Further, medical aids and devices stands for apparatus for extracorporeal use, such as blood oxygenators, blood pumps, blood sensors, detectors, blood tubes, devices for renal dialysis, dialysis membranes, detoxication cartridges and heart-lung machines.

Further, medical aids and devices stands for implanted prostheses such as vascular grafts, bypass prostheses, pacemaker leads and electrodes, prosthetic heart valves, venous valves and other implants.

Further, medical aids and devices also stands for those aids and apparatus which are installed in blood vessels or the heart, e.g. for the recording of data, such as intravascular ultrasound probes and ECG electrodes and for repair operations, e.g. cardiac assist devices and artificial organs such as artificial hearts.

Further, medical aids and devices also stands for those aids and apparatus which are needed in the processing and supply of blood and blood products, such as aids for plasma separation, e.g. centrifuges, membrane filters and cell separators, which are for example used in plasmapheresis, and bags and vessels for blood and blood products.

Further, medical aids and devices also stands for those aids and apparatus which are used in dentistry.

Artificial surface stands for a surface made of non-biological material.

### EXAMPLES

Concerning the disclosure of the compounds of the formula (I), for example as regards the preparation thereof, reference is expressly made to the disclosure of WO 01/47919.

### Determination of the Inhibition of Contact Activation

The contact activation can be measured by means of a global plasma clotting test, the activated partial thromboplastin time (aPTT), which detects the effect on factors of the intrinsic blood clotting system.

The PTT reagent is a mixture of kaolin suspension, that is “silicates”, which mimic the negatively charged foreign surface, and cephalin, that is phospholipids, which are needed as a surface for the conversion of factor XII into factor XIIa. In the presence of a foreign surface, phospholipid and Ca²⁺, factor XII is converted to factor XIIa.

This PTT reagent is added to specially prepared plasma (see examples). The clotting is triggered when the necessary calcium²⁺ ions are present, i.e. by addition of a calcium dichloride solution. The time between calcium²⁺ addition and the onset of clotting is then measured, and the concentration of inhibitor [in μM] which causes a twofold prolongation of the aPTT is stated.

The contact activation is determined by determination of the partial thromboplastin time. The test principle is as follows: the plasma sample is treated with a mixture of the partial thromboplastin cephalin (phospholipid from rabbit brain) and the surface activator kaolin. The contact activation of the intrinsic clotting system up to fibrin formation is thus set in motion.

For the determination of the partial thromboplastin time, blood from healthy volunteers of both sexes, who had not received any medication affecting clotting within the last ten days, was used. The blood is collected in Monovettes (Sarstedt, Nümbrecht) which contain sodium citrate (1 part citrate+9 parts blood) as anticoagulant. To obtain platelet-poor plasma, the citrate (3.8%) whole blood is centrifuged at 2500 g for 10 min at 4° C. and stored at −20° C. For the determination of the clotting time, aliquots of the platelet-poor plasma (0.1 ml) are incubated with increasing concentrations of test substance or the corresponding solvent for 10 mins at 37° C. Next, the clotting time is determined in accordance with the manufacturer's directions (PTT Reagent®, Roche Diagnostics). For this the procedure is as follows: 0.1 ml of PTT reagent is pipetted into the plasma, and the sample incubated for three minutes at 37° C. The clotting is then triggered in a coagulometer by addition of 0.1 ml of calcium chloride solution and the time to onset of clotting is measured. In this manner, the 2-fold prolongation of the aPTT is determined for selected compounds.

TABLE A

| | | Twofold prolongation |
|---|---|---|
| Example from | | of the aPTT |
| WO 01/47919 | Structure | [μM] |
| 17 | 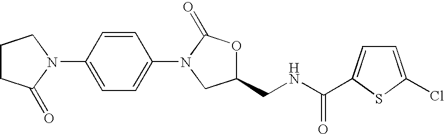 | 1.8 |
| 44 | 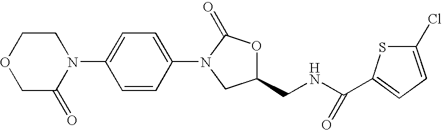 | 0.69 |
| 56 | 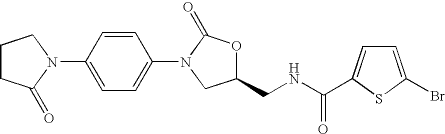 | 4.3 |
| 95 | 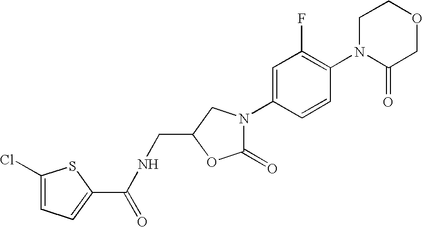 | 0.51 |
| 112 | 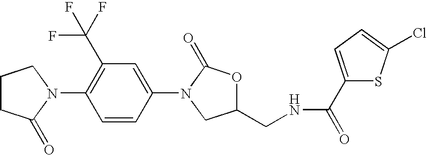 | 1.6 |
| 113 | 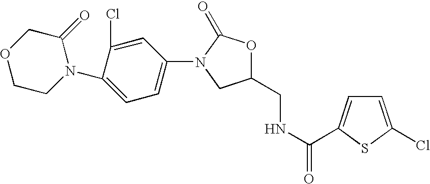 | 0.55 |
| 114 | 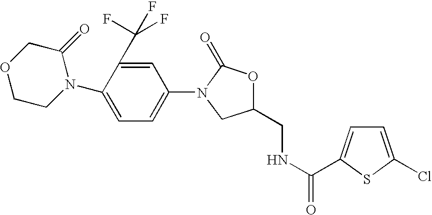 | 2.2 |
| 115 | 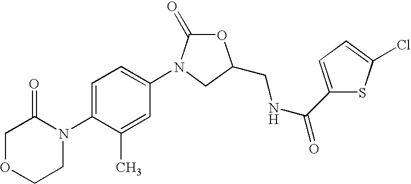 | 1.34 |
| 123 | 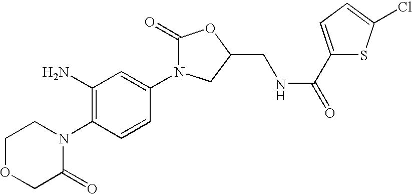 | 1.22 |
| 130a | 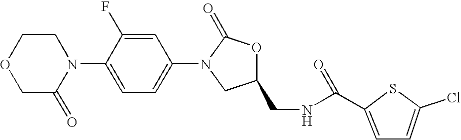 | 0.4 |
| 162 | 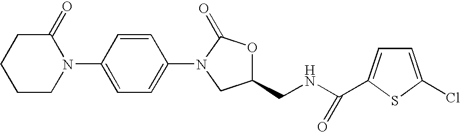 | 2.5 |

1. A method of coating and/or treatment of artificial surfaces of medical aids and/or devices, comprising contacting the medical aids and/or devices with one or more compounds of the formula (I) 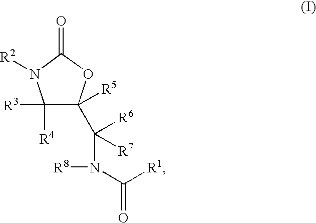
in which
R¹ stands for optionally benzocondensed thiophen (thienyl), which can optionally be singly or multiply substituted;
R² stands for any organic residue;
R³, R⁴, R⁵, R⁶, R⁷ and R⁸ are the same or different and stand for hydrogen or for (C₁-C₆) alkyl,
and salts thereof, solvates thereof and the solvates of salts thereof.

2. The method according to claim 1, wherein
R¹ stands for 2-thiophen, which is substituted in the 5 position with a residue from the group chlorine, bromine, methyl or trifluoromethyl,
R² stands for D-A-:
where
the residue “A” stands for phenylene;
the residue “D” stands for a saturated 5- or 6-membered heterocycle,
which is linked with “A” via a nitrogen atom,
which has a carbonyl group directly adjacent to the linking nitrogen atom and
in which a carbon ring member can be replaced by a hetero atom from the range S, N and O;
where
the previously defined group “A” can optionally be singly or doubly substituted in
the meta position relative to the linkage to the oxazolidinone with a residue from
the group of fluorine, chlorine, nitro, amino, trifluoromethyl, methyl or cyano,
R³, R⁴, R⁵, R⁶, R⁷ and R⁸ stand for hydrogen,
and salts thereof, solvates thereof and the solvates of salts thereof.

3. The method according to claim 1, wherein the compound is 5-chloro-N-({(5S)-2-oxo-3-[4-(3-oxo-4-morpholinyl)phenyl]-1,3-oxazolidin-5-yl}methyl)-2-thiophencarboxamide of the formula 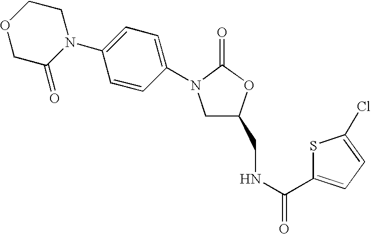
and salts thereof, solvates thereof and the solvates of salts thereof.

4. (canceled)

5. The method of claim 1, further comprising contacting the medical aids and/or devices with one or more other active substances.

6. The method according to claim 5, wherein the compound is 5-chloro-N-({(5S)-2-oxo-3-[4-(3-oxo-4-morpholinyl)phenyl]-1,3-oxazolidin-5-yl}methyl)-2-thiophencarboxamide of the formula 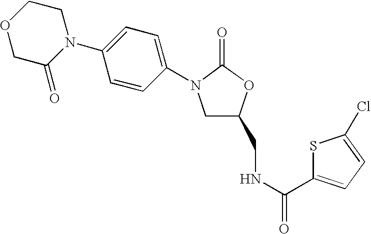
and salts thereof, solvates thereof and the solvates of salts thereof.

7. (canceled)

8. A method for the treatment and/or prophylaxis of fibrin deposition and/or thrombus formation on artificial surfaces by the use of medical aids and/or devices comprising contacting the medical aids and/or devices with one or more compounds of the formula (I) 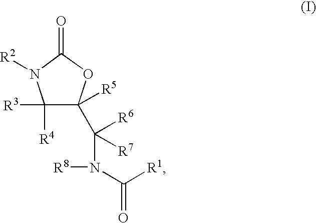
in which
R¹ stands for optionally benzocondensed thiophen (thienyl) which can optionally be singly or multiply substituted:
R² stands for any organic residue;
R³, R⁴, R⁵, R⁶, R⁷ and R⁸ are the same or different and stand for hydrogen or for (C₁-C₆
and salts thereof solvates thereof and the solvates of salts thereof.

9. The method of claim 8 further comprising contacting the medical aids and/or devices and/or thrombus with another active substance suitable for the treatment and/or prophylaxis of fibrin deposition and/or thrombus formation on artificial surfaces, wherein the contacting is by local or systemic administration.

10. The method of claim 8, wherein the one or more compounds of the formula (I), are administered locally and/or systemically.
